(19) United States
(12) Patent Application Publication
(10) Pub. No.: US 2002/0074462 A1
(43) Pub. Date: Jun. 20, 2002

(54) Combination garden hose hanger and storage device

(76) Inventor: Gary J. Pontecorvo, Flemington, NJ (US)

Correspondence Address: KENNETH P. GLYNN, ESQ., 24 Mine Street, Flemington, NJ, 08822-1598, US

(21) Appl. No.: 09/737,031

(22) Filed: Dec. 14, 2000

(51) Int. Cl. A62C 13/76; B05B 15/06

(52) U.S. Cl. 248/89; 248/75; 248/79

(57) ABSTRACT

The present invention is a garden hose hanger and storage device, which includes a main housing having a top, sides and a bottom, and a front and a back. The top has an arcuate shape adapted to receive a garden hose for hanging thereon. The top further includes at least one upwardly projecting member to prevent slippage of a garden hose therefrom. The main housing further has a cabinet-like structure located under the top. The front of the main housing includes at least one door, which has a solid area to establish a back of the cabinet-like structure and is adapted to be opened and closed. The cabinet-like structure has at least one shelf. There are at least two upwardly projecting members located on the top, in which at least one of the members is a front member and one of the members is a back member. The main housing also includes attachment means for attaching the device to a support. The cabinet-like structure includes at least one shelf and a latch for maintaining the at least one door in a closed position, when desired. The device is formed from plastic, metal, wood, composite material, and combinations thereof.

### BACKGROUND OF THE INVENTION

1. Field of the Invention

The present invention relates to garden hose hangers, and more particularly, to those garden hose hangers, which have at least one storage compartment. Moreover, the garden hose hanger is directed to those having storage compartments, which include at least one shelf.

2. Information Disclosure Statement

There are many utility patents and design patents relating to garden hose hangers. The following is representative of the art:

U.S. Pat. No. 5,970,663 to McDonough relates to a storage shed for providing easy access to tools and related items. The shed includes a vertical imperforate back wall positionable at an elevated location with respect to a recipient surface such as the wall of a house. In association with the back wall are a front wall and parallel vertical side edges. A top edge is positionable parallel with the top edge of the back wall. The front wall has at least one large rectangular opening therein. Side walls couple the front and back walls. At least one door is positionable over a respective opening in the front wall. A pair of vertical side braces are located in the space formed between the front and rear walls and secured to the lateral side walls. The braces have horizontal slots at spaced elevations for shelf-receiving purposes, the slots being positioned in facing relationship in the braces. A plurality of shelves with lateral edges are received in the slots of the braces. A plurality of horizontal U-shaped rail sections have free ends in contact with the back wall and are located between opposed braces. The rail sections have horizontally aligned apertures along their lengths.

U.S. Pat. No. 5,699,987 to Romaneschi, et al. discloses a hose hanging apparatus having a drawer. The hose hanging apparatus provides a main body supporting a front railing and a back plate having a rear railing that allows a user to coil hose about the main body between the front and back railings. A drawer is carried by the main body and provides well ventilated and drained storage for tools and supplies. The drawer provides bottom mounted riser bars that cause the drawer to elevate as it is opened, thus tending to prevent the drawer from inadvertently falling out. The riser bars tend to compensate for the drawer cavity having a smaller rear portion and a larger front portion as a result of requirements of the plastic molding process by which the main body is manufactured.

U.S. Pat. No. 5,419,362 to Blackaby describes and illustrates a hose supporting device having an inboard backing plate of a planar configuration positionable in a generally vertical orientation adjacent the side of a house. The house is proximate to a water faucet as a type having a horizontal pipe extending through the side of the house and a water bib positioned thereof positionable over the water bib of the pipe. The opening has a pair of generally parallel edges extending downwardly with a vertical opening for positioning the aperture over the bib. The backing plate has a closed upper extent, vertical side extent and a lower extent. There is also an outboard retaining plate having an upper arcuate surface at an elevational extent, concentric with, but essentially the same as the arcuate surface of the inboard backing plate and having a lower arcuate surface essentially concentric with the upper backing plate and with vertical side edges generally co-extensive with the side.

U.S. Pat. No. Des. 408,270 to Tisbo et al. illustrates a hose hanger having a front with a door, and a lower rear portion having cut-outs.

U.S. Pat. No. Des. 328,173 to Nelson illustrates a garden hose reel caddy having a reel on a device having wheels. A garden hose is wound around the reel by moving arms on the reel.

U.S. Pat. No. Des 334,529 to Guilbert illustrates a garden hose holder having a generally M-shape. The holder is designed to rest a hose near a center of the device.

Notwithstanding the aforesaid prior art, the present invention system is neither taught nor rendered obvious thereby.

### SUMMARY OF THE INVENTION

The present invention is a garden hose hanger and storage device, which includes a main housing having top, sides and a bottom, and a front and a back. The top has an arcuate shape adapted to receive a garden hose for hanging thereon. The top further includes at least one upwardly projecting member to prevent slippage of a garden hose therefrom. The main housing further has a cabinet-like structure located under the top.

The front of the main housing includes at least one door adapted to be opened and closed. The back includes a solid area to establish a back of the cabinet-like structure. The cabinet-like structure has at least one shelf. There are at least two upwardly projecting members located on the top, in which at least one of the members is a front member and one of the members is a back member.

Moreover, the main housing includes attachment means for attaching the device to a support. Such attachment means may be any known or to be developed attachment means, which would enable a user to attach the device to a structure such as a home, a building, a shed, a fence, and the like. These may include brackets which are received by orifices on the support, orifices which sit on a bracket on the support, an arrow-shaped protrusion which mates with a corresponding aperture on the support, metal strips which are held in place by a slide down cover on the support, and the like.

The cabinet-like structure may include one shelf or it may be divided into a plurality of separate compartments having a plurality of shelves. The door covers the cabinet-like structure and includes a latch for maintaining the door in a closed position, when desired. The door may include hooks on both an inside and outside of the door, for hanging various items thereon. There may be more than one door, e.g. double doors or over/under doors.

The device may be formed from materials selected from the group consisting of plastic, metal, wood, composite material, and combinations thereof. In preferred embodiments, the material is molded plastic. The cabinet-like structure may further include at least one tie-down attachment affixed thereto for tying down items to be stored. Such tie-down attachment(s) may be filamentary loop and hook fasteners, such as VELCRO®; nylon ties; cords; pull strings with barrel locks; and the like.

### BRIEF DESCRIPTION OF THE DRAWINGS

The present invention should be more fully understood when the specification herein is taken in conjunction with the drawings appended hereto wherein:

FIGS. 1, 2 and 3 show a top view with a hose, a side view without a hose, and a front view with the hose of a present invention garden hose hanger and storage device, respectively;

FIG. 4 shows a front view of a present invention cabinet-like structure located under a top of said present invention device, shown in FIG. 1 through FIG. 3;

FIG. 5 shows a side view of an alternative embodiment of a present invention garden hose hanger and storage device;

FIG. 6 shows a side view of another alternative embodiment of a present invention garden hose hanger and storage device;

FIG. 7 shows a front view of an alternative embodiment of a present invention garden hose hanger and storage device having a plurality of doors and a nearly rectangular shape; and

FIG. 8 shows a rear view of a present invention garden hose hanger and storage device having an alternative embodiment of attachment means for attaching the device to a support.

### DETAILED DESCRIPTION OF THE PRESENT INVENTION

The present invention is a garden hose hanger and storage device, which includes a main housing having top, sides and a bottom, and a front and a back. The top has an arcuate shape adapted to receive a garden hose for hanging thereon. The top further includes at least one upwardly projecting member to prevent slippage of a garden hose therefrom. The main housing further has a cabinet-like structure located under the top and has an oval shape. However, any geometric shape, such as circular, polygonal, and the like, are within the scope of the present invention.

The front of the main housing includes at least one door adapted to be opened and closed. The back includes a solid area to establish a back of the cabinet-like structure. The cabinet-like structure has at least one shelf. There are at least two upwardly projecting members located on the top, in which at least one of the members is a front member and one of the members is a back member.

Moreover, the main housing includes attachment means for attaching the device to a support. Such attachment means may be any known or to be developed attachment means, which would enable a user to attach the device to a structure such as a home, a building, a shed, a fence, and the like. These may include brackets which are received by orifices on the support, orifices which sit on a bracket on the support, an arrow-shaped protrusion which mates with a corresponding aperture on the support, metal strips which are held in place by a slide down cover on the support, and the like.

The cabinet-like structure may include one shelf or it may be divided into a plurality of separate compartments having a plurality of shelves. The door covers the cabinet-like structure and includes a latch for maintaining the door in a closed position, when desired. The door may include hooks on both an inside and outside of the door, for hanging various items thereon. There may be more than one door, e.g. double doors or over/under doors.

The device may be formed from materials selected from the group consisting of plastic, metal, wood, composite material, and combinations thereof. In preferred embodiments, the material is molded plastic. In addition, the door may be made from plywood. The cabinet-like structure further includes at least one tie-down attachment affixed thereto for tying down items to be stored. Such tie-down attachment(s) may be filamentary loop and hook fasteners, such as VELCRO®; nylon ties; cords; pull strings with barrel locks; and the like.

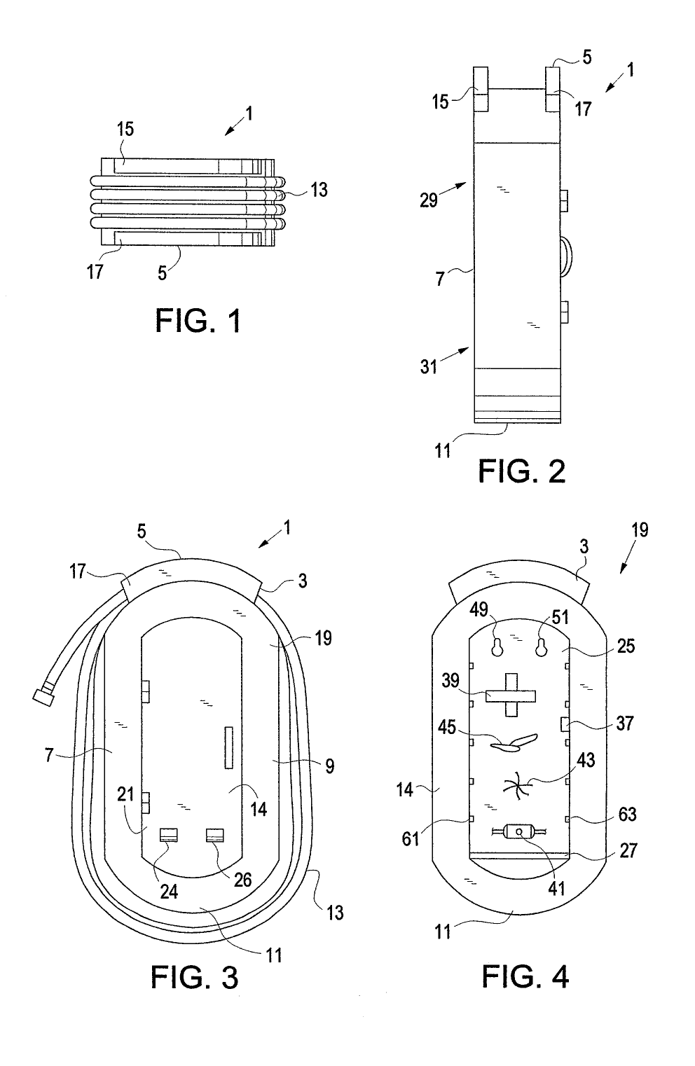

Referring now to FIGS. 1, 2, 3 and 4, there is shown a top view, a side view, a front view, and an interior view of a present invention garden hose hanger and storage device 1, respectively. The device 1 includes a main housing 3 having a top 5, sides 7 and 9, a bottom 11, a front 14 and a back 25. The top 5 has an arcuate shape adapted to receive a garden hose 13 for hanging thereon.

The top 5 further includes at least one upwardly projecting member 15, 17 to prevent slippage of a garden hose therefrom. At least one of the upwardly projecting members 17 is a front member and one of the members 15 is a back member. Note that the main housing 3 has a generally oval shape in a frontal view. However, various shapes, such as polygonal, circular, and the like, are within the scope of the present invention.

The main housing 3 further includes a cabinet-like structure 19, located under the top 5. The front 14 of the main housing 3 includes a door 21 adapted to be opened and closed. The back 25 of the main housing 3 includes a solid area to establish a back of the cabinet-like structure 19. The door 21 includes at least one hook 24, 26 on outside of the door 21, for hanging various items thereon. At least one hook, not shown, may be included on an inside of the door 21. The cabinet-like structure 19 has at least one shelf 27.

The main housing 3 also includes attachment means for attaching the device 1 to a support. As shown in FIG. 2, attachment means is at least one bracket 29, 31 with at least one orifice in a support to receive at least one securing member. Other attachment means will be discussed hereinafter below.

Referring specifically to FIG. 4, the cabinet-like structure 19 includes at least one shelf 27, and a latch 37 for maintaining the door in a closed position, when desired. The at least one shelf is adjustable and may be moved into any shelf placement members, such as 61, 63. The cabinet-like structure 19 further includes at least one tie-down attachment 39, 41, 43, 45 affixed thereto for tying down items to be stored. Such tie-down attachment(s) may be filamentary loop and hook fasteners 39, such as VELCRO®; pull strings with barrel locks 41; cords 43; nylon ties 45; and the like. There is also shown at least one orifice 49, 51 located on the back 25 of the main housing 3 for attaching the device 1 to a support.

The device 1 may be formed from materials selected from the group consisting of plastic, metal, wood, composite material, and combinations thereof. In preferred embodiments, the material is molded plastic. In addition, the door 21 may be made from plywood.

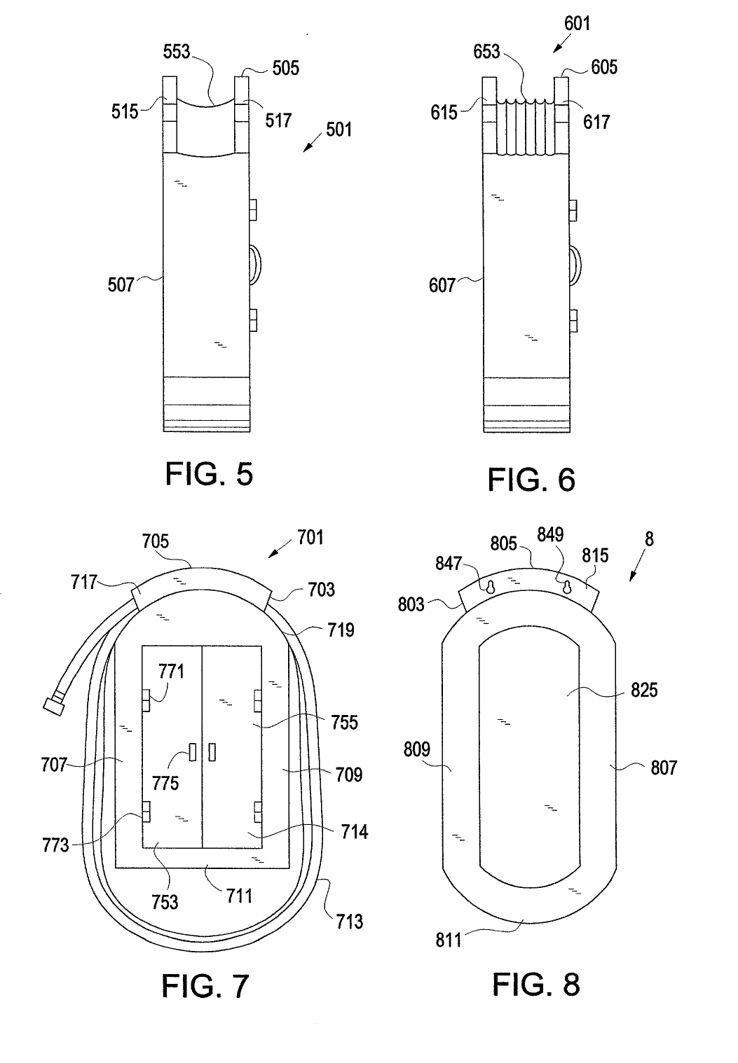

FIG. 5 shows a side view of an alternative embodiment of a present invention garden hose hanger and storage device 501. As shown, a garden hose placement portion 553 for placing a garden hose between projecting portions 515 and 517 is arcuate.

FIG. 6 shows a side view of an alternative embodiment of a present invention garden hose hanger and storage device 601. As shown, a garden hose placement portion 653 for placing a garden hose between projecting portions 615 and 617 is grooved for facilitating placement of a garden hose.

FIG. 7 shows an alternative embodiment of a present invention garden hose hanger and storage device 701 having a plurality of doors 753, 755. The door 753 has a handle 775 and is mounted to a cabinet-like structure 719 through a plurality of hinges 771, 773. The door 755 has a similar handle and is similarly mounted. Similar parts to those identified by FIG. 3 are similarly numbered but beginning with “700”. As shown, a shape of the frontal view is approximately rectangular.

Referring now to FIG. 8, there is shown a rear view of a present invention garden hose hanger and storage device 801 having an alternative embodiment of attachment means 847, 849 for attaching the device 801 to a support. Similar parts to those identified in FIGS. 3 and 4 are similarly numbered, but beginning with “800”. In this embodiment, there is shown at least one orifice 847, 849 located on at least one upwardly projecting member 815 for attaching the device 801 to a support.

Obviously, numerous modifications and variations of the present invention are possible in light of the above teachings. For example, various shapes of the device is included in the scope of the present invention, as long as it may provide abase for a hose to be places around. It is, therefore, understood that within the scope of the appended claims, the invention may be practiced otherwise than as specifically described herein.

What is claimed is:

1. A garden hose hanger and storage device, which comprises:
a main housing having top, sides and a bottom, and a front and a back, said top having an arcuate shape adapted to receive a garden hose for hanging thereon, said top further having at least one upwardly projecting member to prevent slippage of a garden hose therefrom, said main housing further having a cabinet-like structure located under said top, said front including at least one door adapted to be opened and closed, said back including a solid area to establish a back of said cabinet-like structure, said cabinet-like structure including at least one shelf.

2. The garden hose hanger and storage device of claim 1 wherein there are at least two upwardly projecting members located on said top, at least one of said members being a front member and one said members being a back member.

3. The garden hose hanger and storage device of claim 1 wherein there are a plurality of shelves located within said cabinet-like structure.

4. The garden hose hanger and storage device of claim 2 wherein there are a plurality of shelves located within said cabinet-like structure.

5. The garden hose hanger and storage device of claim 1 wherein said main housing has a generally oval shape in a frontal view.

6. The garden hose hanger and storage device of claim 2 wherein said main housing has a generally oval shape in a frontal view.

7. The garden hose hanger and storage device of claim 1 wherein said main housing includes attachment means for attaching said device to a support.

8. The garden hose hanger and storage device of claim 7 wherein said attachment means is at least one bracket with at least one orifice to receive at least one securing member.

9. The garden hose hanger and storage device of claim 7 wherein said attachment means is at least one orifice located in said back of said main housing for attaching said device to a support.

10. The garden hose hanger and storage device of claim 7 wherein said attachment means is at least one orifice located on said at least one upwardly projecting member for attaching said device to a support.

11. The garden hose hanger and storage device of claim 1 wherein said cabinet-like structure is divided into a plurality of separate compartments.

12. The garden hose hanger and storage device of claim 3 wherein said cabinet-like structure is divided into a plurality of separate compartments.

13. The garden hose hanger and storage device of claim 1 wherein said cabinet-like structure includes a latch for maintaining said at least one door in a closed position when desired.

14. The garden hose hanger and storage device of claim 1 wherein said device is formed from materials selected form the group consisting of plastic, metal, wood, composite material, and combinations thereof.

15. The garden hose hanger and storage device of claim 14 wherein said material is molded plastic.

16. The garden hose hanger and storage device of claim 1 wherein said cabinet-like structure includes at least one tie-down attachment affixed thereto for tying down items to be stored.

17. The garden hose hanger and storage device of claim 16 wherein said at least one tie-down attachment is filamentary loop and hook fasteners.

18. The garden hose hanger and storage device of claim 16 wherein said at least one tie-down attachment is nylon ties.

19. The garden hose hanger and storage device of claim 16 wherein said at least one tie-down attachment is cords.

20. The garden hose hanger and storage device of claim 19 wherein said at least one tie-down attachment is pull strings with barrel locks.
